(19) United States
(12) Patent Application Publication
(10) Pub. No.: US 2016/0241842 A1
(43) Pub. Date: Aug. 18, 2016

(54) Digital Stereo Photographic System

(71) Applicant: Billy D. Newbery, San Diego, CA (US)

(72) Inventor: Billy D. Newbery, San Diego, CA (US)

(21) Appl. No.: 15/139,014

(22) Filed: Apr. 26, 2016

Related U.S. Application Data
(63) Continuation-in-part of application No. 14/660,232, filed on Mar. 17, 2015.
Application No. 14/660,232 is a division of application No. 11/818,519, filed on Jun. 13, 2007, now Pat. No. 8,982,181.
(60) Provisional application No. 60/813,052, filed on Jun. 13, 2006.

(51) Int. Cl. H04N 13/02; H04N 5/232; H04N 13/00; H04N 13/04

(52) U.S. Cl. CPC H04N 13/0239; H04N 13/0404; H04N 13/0452; H04N 13/0285; H04N 5/23293; H04N 5/23212; H04N 13/0022

(57) ABSTRACT

The invention provides a system for three-dimensional (3D) (stereo) still and movie photography in a digital format including capturing the image or photo, viewing, printing, and projecting. The system allows downloading images to a computer, editing, enhancing or modifying, saving locally or to other storage medium, and the printing of stills. This invention allows viewing of the image in the camera in 3D, prior to, during, immediately after exposure and at any other time after exposure. Images are further improved using computer processing after exposure in editing, enhancing, color correcting, adding text and art. The system allows viewing 2D and 3D images in the camera, a hand held viewer, on a computer screen, standard and 3D television sets, printed pairs, and other formats. Images may be viewed with conventional or 3D digital projectors using polarized glasses. The camera provides the three-dimensional image capture in a digital format and retains full 2D capability.

### RELATED APPLICATIONS

This application claims the benefit of priority from United States Divisional patent application Ser. No. 14/660,232, filed on Mar. 17, 2015, and currently co-pending, which in turn claims the benefit of priority to U.S. Pat. No. 8,982,181, issued on Mar. 17, 2015, which in turn claims the benefit of priority to U.S. Provisional Application Ser. No. 60/813,052, filed by this inventor on Jun. 13, 2006, and currently expired.

### FIELD OF THE INVENTION

This invention relates generally to digital photography. This invention is more particularly, though not exclusively, useful as a stereoscopic digital imaging camera and system to provide enhanced digital image capture and viewing.

### BACKGROUND OF THE INVENTION

Stereo photography was very popular in the world from the very beginning of photography. The stereoscope was invented in 1838. The earliest stereos were, mostly, made by commercial photographers, sold to the public and viewed with a hand held stereoscope. These devices are still available in kit form and on the used market, but it is not the best format today. Personal stereo still photography was quite popular in the 1950's, 1960's and some in the 1970's. Most cameras were 35 mm with two matched lenses, separated by a distance approximately equal to human eyes. Its popularity faded after the 1970's even though there are thousands of users yet today, some belonging to hundreds of stereo camera clubs throughout the world.

Stereo photography is extremely enjoyable as it adds a breathtaking depth dimension and makes you feel like you are there, where the photo was taken. It makes a photo become alive. Good stereo brings out a rash of comments by viewers—Exciting! Stupendous! Colossal! Wow! This is super! Really good! Cool! Ooh! I feel like I can reach out and touch it! This is great! Outstanding! Magnificent!

In light of the popularity of stereoscopic imaging and viewing, the present invention will reintroduce this phenomenal technique to the world—in a significantly better and more enhanceable format, and with vastly improved viewing methods. It will also provide the extremely important feature of immediate stereo viewing before and after exposure to instantly confirm that a satisfactory image was taken.

### BRIEF SUMMARY OF THE INVENTION

The digital stereo photographic system of the present invention is a complete digital stereo photographic system consisting of new devices and technology with components that include the digital stereo still and movie camera, hand-held viewer, viewer attachment, computer viewer, liquid crystal shutter and 3D glasses, projector, and software for editing, adding text, adding audio, printing, slide bar, tripod, viewing glasses and a projector screen. The digital stereo photographic system has all of the features of a standard conventional still digital camera. The camera would have two identical lenses separated horizontally at a distance, which will provide a stereo effect. It also features one or two viewing liquid crystal displays and dual internal charge coupled devices. Left and right image pairs would be exposed simultaneously to the CCDs yet show in the one or two LCD screens and recorded onto a memory device as separate images. The two identical lenses may be retractable and extendable and may be linked together.

Other attributes include zoom, viewfinder, electronic viewer, remote control, an image quality of at least 5 megapixels and preferably more. In more modern digital photography and movies, an image quality of at least 14 megapixels is preferred. A memory format of JPEG (Joint Photographic Experts Group), MPO (Multi Picture Format), or RAW for stills and MPEG (Movie Picture Experts Group), or AVI (Audio Visual Interface for movies) may be produced, and exposure setting of automatic, aperture priority, shutter priority or manual, an automatic or manual internal flash with a hot shoe providing for an external flash device. The system of the present invention may accept any readily available memory card, and powered by any type of battery or external auxiliary power supply and input along with a USB port for transferring information to and from a computer, and an HDMI (High Definition Multimedia Interface) port for 3D televisions.

Controls include a power on/off button, capture mode selector dial, shutter button, focus/depth-of-field setup, zoom lever, audio button, navigator buttons, menu button, display button, delete button and image selector.

The viewer attachment is used to view the single or dual LCD screens in a 3D format before and after exposure and capture. This device will also be used to view stereo pairs, in the camera or hand held viewer that have been saved in a memory card. The photos may be viewed individually or in a slide show format.

The computer viewer is similar to the viewer attachment, except that it is specifically for viewing stereo images on a computer. These images to be viewed would be side-by-side and approximately 5 inches wide each.

The hand-held viewer is used to view digital stereo pairs in two or three (3) dimensions. It uses the viewer attachment and has a single or dual LCD device.

Liquid crystal shutter and 3D glasses for viewing 3D images on a computer screen, prints, or on a standard or 3D TV will be included with the system of the present invention. Software to create the VHS, BD (Blu-ray Disk) or DVD (Digital Video Disk) is included as part of the system of the present invention. The Liquid Crystal Shutter and 3D glasses are shaped like and worn as eyeglasses.

A stereo projector is needed to project stereo stills and movies on a screen for viewing by large audiences. The projector would be a dual projector system, or two standard digital projectors with unique characteristics for stereo.

Controls and software for photo selection and slide show characteristics are included. In-camera software would be provided to support all conventional digital camera functions, and stereo related function. Computer software for editing still photos would be similar to existing professional level photo editing software. General editing will be conducted on one image, but simultaneously recorded on the other image, whether visible on the computer screen or not. Further adjustments would be performed manually In a 3D view by use of the keyboard. Software for printing photos would be similar to existing professional level photo editing software. The photographic images are processed in the normal way and using the included software.

Any standard BD, DVD player, or VCR, when equipped with a 3D TV Box, would be used to play the 3D images on a standard TV using liquid crystal shutter glasses. 3D TVs would use shutter or 3D glasses and would not require the 3D Box. Software for creating the slide show and copying to VHS, BD, or DVD is included.

A slide bar would be used for hypo-stereo and hyper-stereo photos. It would have a tripod attachment insert on the bottom and a camera attachment on the top for interfacing with these items. It would include adjustments for camera lens separation and exposure separation.

### BRIEF DESCRIPTION OF FIGURES

The nature, objects, and advantages of the present invention will become more apparent to those skilled in the art after considering the following detailed description in connection with the accompanying drawings, in which like reference numerals designate like parts throughout, and wherein:

FIG. 1 illustrates the three dimensional photographing device ca era) from the rear/top/right point of view;

FIG. 2 illustrates the three dimensional photographing device (camera) from the front/top/left point of view;

FIG. 3 illustrates the viewer attachment. When attached to the camera or the hand held viewer the scenes or captured scenes are viewed in three-dimensions (stereo);

FIG. 4 illustrates the hand held viewing apparatus used to view captured photos and slide shows;

FIG. 5 is a block diagram illustrating the operation and flow of information in the camera set-up mode;

FIG. 6 is a block diagram illustrating the operation and flow of information in the camera capture mode;

FIG. 7 is a block diagram illustrating the operation and flow of information in computer editing/viewing mode;

FIG. 8 is a block diagram illustrating the operation and flow of information in the camera and hand held viewer viewing mode;

FIG. 9 is a block diagram illustrating the operation and flow of information in the TV viewing mode;

FIG. 10 illustrates the stereo projection mode;

FIG. 11 illustrates the LCD displays of the camera in the Depth of Held (DOF) view of the Capture mode;

FIG. 12 illustrates the LCD displays of the camera in the Capture and Photo viewing modes;

FIG. 13 is a perspective view of the camera showing a Lenticular screen used in place of dual LCDs;

FIG. 14 is a perspective view of the hand held viewing apparatus having a Lenticular screen;

FIG. 15 is a block diagram illustrating the operation and flow of information in the camera set-up mode where the camera uses a Lenticular lens; and

FIG. 16 is a block diagram illustrating the operation and flow of information in the camera and hand-held viewer, when equipped with a Lenticular lens, in the viewing mode.

### DETAILED DESCRIPTION

The digital stereo photographic system of the present invention is a complete digital stereo photographic system consisting of new devices and technology as identified below. In order to facilitate the discussion of the present invention, the various parts and components are generally listed in the following paragraph, and more fully described in subsequent paragraphs.

The Digital Stereo Photographic System would consist of the following major components:

I. Camera, Digital Stereo Still and Movie (also a hand-held viewer)

II. Viewer Attachment

III. Computer Viewer

IV. Hand-held viewer

V. Liquid Crystal Shutter and 3D glasses

VI. Projector

VII. Software for editing, adding text, adding audio, printing, etc,

VIII. Digital Video Disc (DVD) and BD Player and Video Cassette Recorder (VCR)

IX. Accessories:
Slide bar
Tripod
Viewing glasses
Projector screen

### I. Camera, Digital Stereo Still and Movie

The stereo digital still and movie camera, also known as a 3D camera, has all of the standard features of a conventional digital still camera, including but not limited to the following:

Date and time recording

Exposure and aperture data

Image stabilization

Instant review

Image Deletion

Selective review

Slide show features

Movie picture mode (Video)

Macro mode

Resolution selection

Sensitivity (ISO) selection

Time-lapse exposure

Self-timer

Histogram presentation

Auto power off at selected time

Capture mode selection

The camera has two identical lenses separated horizontally. Any distance will provide a stereo effect, but since the eyes are about 2.74 inches (center-to-center) this will be the norm and most realistic. It also has two viewing Liquid Crystal Display (LCD) screens separated by approximately 2.50 inches (center-to-center) on the backside and dual internal Charge Coupled Devices (CCDs). Left and Right Image pairs would be exposed simultaneously to the CCDs, shown in the LCD screens, identified with a number followed by an L or R, for left or right, and recorded onto a memory device as separate images. Photos would be viewed in the camera with the unaided eye or more easily with the viewer attachment described below. In an alternative embodiment, the matched LCD screens are replaced with a single Lenticular screen. This viewing screen will be daylight visible and will display the photographic images for composition, depth, color, etc. prior to and after exposure. Photos and movies can be viewed in one of three (3) modes: side-by-side 3D, lenticular 3D, and lenticular 2D. These options will be menu selectable. In the side-by-side mode, the viewing screen is split at the center showing the left image on the left side and the right image on the right side. 3D viewing is aided by the viewer attachment or free viewed (left eye sees the left image while the right eye sees the right image) with the unaided eye. In the Lenticular mode, the images are viewed in the LCD behind a high-resolution lenticular lens. Software in the camera divides the images into narrow strips interlaced behind the lenticular screen. The lenticular lenses separate the left and right images so they are viewed by their respective eye. In this mode, the image size is the full width of the LCD and no glasses are needed. In 2D mode, the camera will take and display only two-dimensional images. Images may be viewed individually or in a slide show format. Ability to select photos for viewing or a slide show is included in the internal software of the camera and the hand held viewer.

Lenses—Two identical, with linked iris, shutter, etc. and a short focal length to provide maximum depth of field and a wide angle of view. For compactness, the lenses may be retractable/extendable and may be linked together.

Zoom—3× optical or more plus digital of about 3×.

Viewfinder—Optical, centered and linked to zoom (non-stereo).

Image quality—At least 5 megapixels for each CCD, 10 or more is desirable. In certain embodiments, at least 14 megapixels is desirable for each CCD.

Resolution per exposure and viewed image size—Resolution and pixel size as well as the viewed image size are selectable from the menu. Sizes up to the maximum with the following height to width ratios 4×5, 4×6, 5×7, 1×1, 9×16 and the standard film stereo camera ratio 24×23 and user custom selection.

Memory format—JPEG (Joint Photographic Experts Group), MPO (Multi Picture Object) and RAW for stills and MPEG and AVI for movies, selectable from a menu.

Image selection—Selectable from the menu: Left only, right only or both images for exposure (both would be the default). This feature is used in taking hyper-stereo photos (lenses much farther apart than the norm) and often used for distant subjects to give greater depth and used in taking hypo-stereo photos (lenses closer together from the norm), often used for close-up subjects to make the depth more realistic. The user would select the side for the first exposure and after exposing, the camera would automatically switch to the other side. The user would move the camera the appropriate distance and expose the second image. For the dual LCD configuration, the first image would remain visible in one LCD and the second image to be captured would be visible in the other LCD allowing precise alignment. For the lenticular configuration, the first image would be visible and the second would be superimposerd in the lenticular screen for precise alignment. In addition, more than one separation can be tried by selecting this option from the menu and selecting which side is first exposed. In this case, the first exposure taken is reserved and would remain visible while the subsequent exposures are captured. Each 3D image would be saved with a different exposure number. These techniques require the use of a tripod with a slide bar, or other means of varying the lens separation, while maintaining vertical alignment, for each image pair, Exposure—Selectable from the menu: Automatic, aperture priority, shutter priority, or manual (Automatic would be the default).

Flash—Selectable from the menu: Automatic or manual, internal and/or external. A flash is built in to the camera. A hot shoe is incorporated on the top center providing for an external flash device. For extended flash range, a slave flash may be used. Red-eye reduction option would be included in the menu,

Memory Card—Compact Flash Type I and Type II Secure Digital High Capacity (SDHC) and Microdrive capability or equivalent.

Power—Battery, AA size (rechargeable) is recommended. External auxiliary power supply and input to camera also included.

Audio—The camera includes provisions to add audio, for each photo pair. The length of time is selectable in the menu with a default of 20 seconds. Audio can be added before or after exposures by pressing the audio control button and following instructions on an LCD monitor. Audio added prior to exposure would be included with the next exposure. After exposure, while viewing the selected image in an LCD monitor, the audio would be added to the selected image. Audio can also be added to any image by a computer. In movie mode, audio is added during or after image capture.

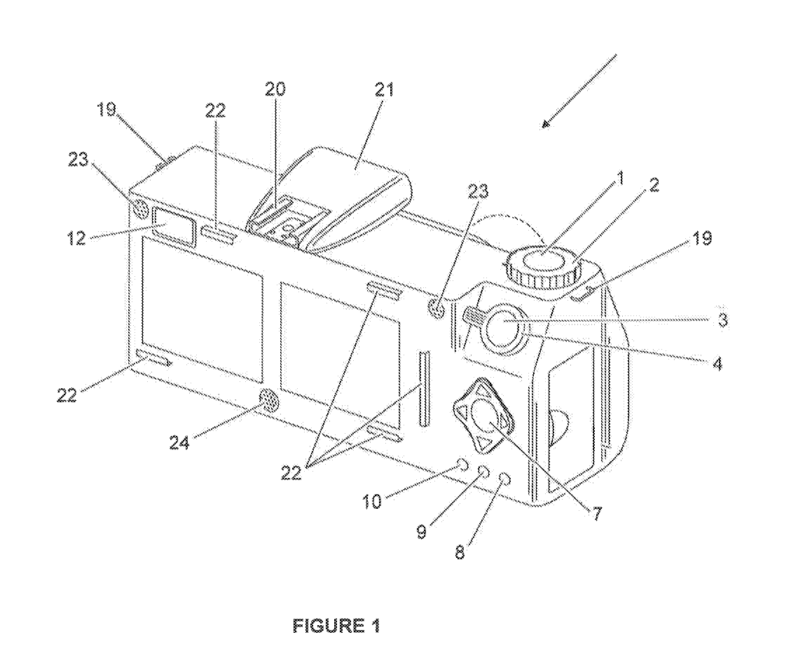

Exemplary Camera controls, as shown in FIG. 1:

1. Power on/off button—Activates camera and extends lenses;

2 Capture mode selector dial—Selects the following modes: 3D (3 Dimensional Stereo), 2D (2 Dimensional), movie (moving images), night (dark scenes), filtered (color filters including black and white, sepia, red, green, blue and yellow). All in 3D except 2D mode.

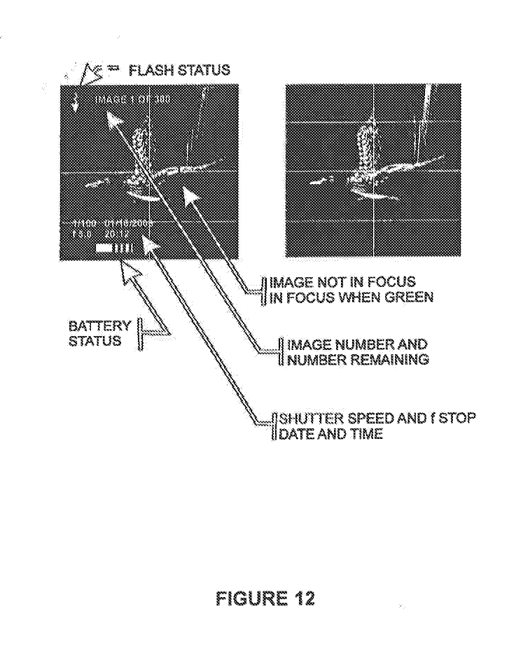

3. Shutter button—An initial half-way press will enable the Photo and Capture View on either LCDs or the lenticular screen (see FIG. 12 for a typical configuration) activate focus, and set other functions. A pair of red brackets and the aperture/shutter speed will be also shown on one LCD (can be both) or the lenticular screen. When ready for exposure, the red brackets will change to green and move closer together. This view will stay on for several seconds unless the DOF lever is moved, after the halfway press is released. Final pressing the shutter button will expose the images. The exposure may be delayed (menu selected) to allow the photographer to enter the scene.

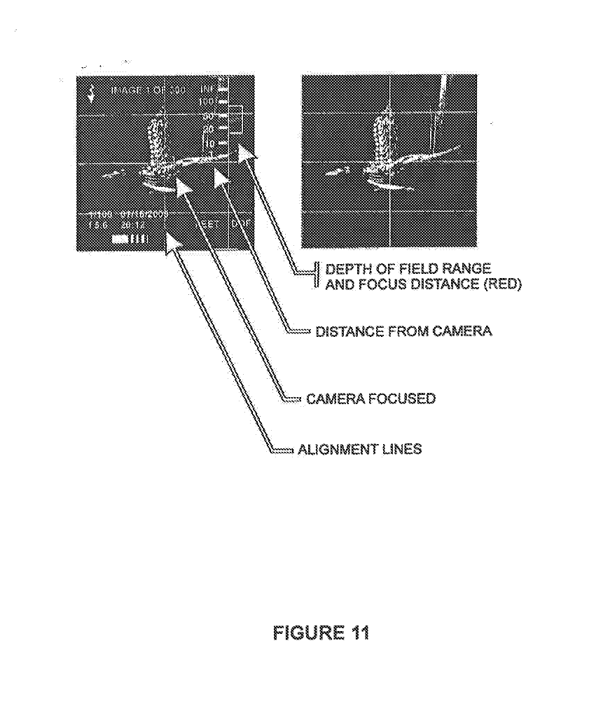

4. Focus/Depth-of-Field (DOF)—Selectable in Setup—Automatic Only, DOF Only, or Auto/DOF. In the Auto/DOF mode, the focus would be automatic as described above, with DOF manual override. To engage the DOF feature after the shutter button is pressed halfway and the Photo View is present, move the depth-of-field lever to enable the DOF view (See FIG. 11 for a typical configuration). A range scale will appear on one or both of the LCDs or the lenticular screen showing distance from camera scale range (near zero to infinity) and adjacent to that, a sliding depth-of-field bar showing the range of sharp focus with a red line for the focus distance—move the lever up or forward to move the depth-of-field bar up, or move the lever down to move the depth-of-field bar down. As the depth-of-field bar moves slowly, the range scale and the red line focus depth would move in the opposite direction a little faster. The dimensions of the range would be feet/inches or metric (selectable in Setup) and arranged in a logarithmic order with infinity approximately at the 100-foot level. The depth-of-field range would be calculated by the internal software. The depth-of field range is a function of aperture, focal length, and focus distance. In the Auto Only mode, the DOF lever would serve no function, and must be used in the DOF Only mode. Zoom lever—Moving this lever would zoom the lens for detail inspection or a closer viewing aspect. In movie mode, zoom can be made before or during the capture of a movie and in the viewing mode (this view is not saved),

5. Zoom lever—Moving this lever would zoom the lens for detail inspection or a closer viewing aspect. In movie mode, zoom can be made before or during the capture of a movie and in the viewing mode (this view is not saved).

6. Audio button—Initial press of the button will enable the audio function and show “AUDIO ENABLED—PRESS TO START” in an LCD screen. Pressing the audio button again will start the recording and show, on the LCD monitor, a countdown of the remaining time. After recording, “PRESS TO PLAY AUDIO” will show on the LCD and pressing the button again will play the audio. The play audio function will remain enabled for 10 seconds,

7. Navigator buttons—Four way navigation buttons with center OK or SELECT button.

8. Menu button—Pressing this button will bring up the menu. Navigation will be by the Navigator Buttons. Camera setup or capture modes will initially be selected. Setup will include features that are primarily constant, such as date, time, language, volume, format, etc. The shooting mode will include features and attributes relative to the shot, such as still or movie mode, ISO, shutter speed, aperture, image size, etc.

9. Display button—Pressing this button will show image number, date/time of exposure, and battery condition. Pressing this button again will add other details, including a histogram, aperture, shutter speed, recorded pixels, quality level, white balance, AE metering, and ISO speed

10. Delete button—Pressing the button will enable the delete function and show “DELETE CANCEL” on the LCD. The word CANCEL will be highlighted. For protection against accidental erasure, the navigation button must be used to highlight the word DELETE, and then pressing the center button will delete the captured photo.

Other controls available include a remote control function to allow a user to remotely initiate the capture of an image or movie and control the playback of an image or movie. In certain embodiments, the exemplary controls listed above, such as capture selection, shutter control, focus/DOF, and zoom, may be controlled remotely. If the camera is remotely located (not within sight of the user) the electronic viewer may be turned off. A separate transmitter/receiver system may be used to send data from and to a computer, including the photographic images.

Interfaces for the digital stereo photographic system of the present invention include, but are not limited to, the following:

Auxiliary power input from included power supply;

USB (Universal Serial Bus) port to send and receive all data to and from a computer;

Audio/Video output to send signals to a VCR, BD or DVD player, and HDMI to a TV set, for recording or viewing; and

Memory card.

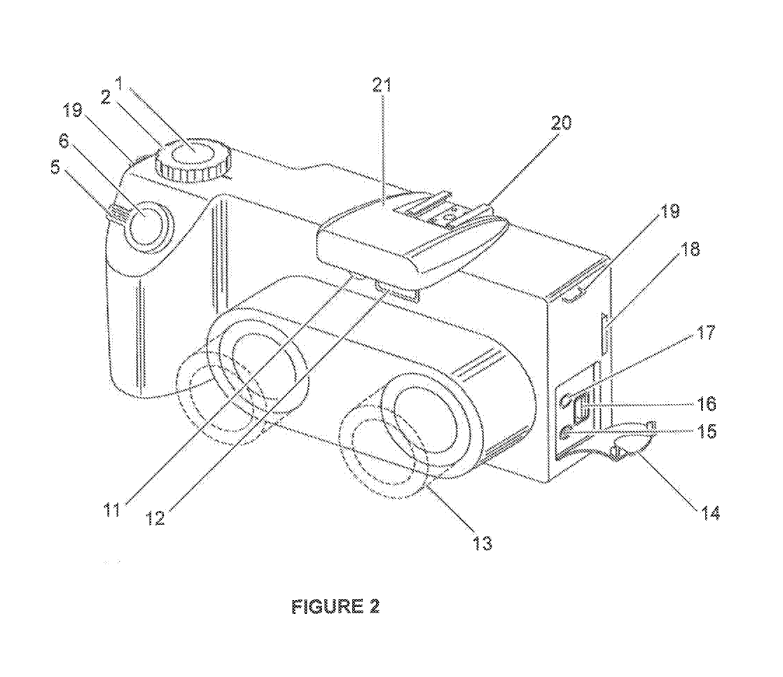

An exemplary embodiment of the present invention, and its exemplary configuration, is described as follows: The camera will have a width of up to approximately 6.5 inches and a depth of up to approximately 3.5 inches, with lenses extended. A grip (extending forward about one inch from the main body) on the right side would house the batteries and the memory card. The power on/off button (1) and the capture mode selector dial (2) would encircle the on/off button. The shutter button (3) would be on the top and at the rear position of the grip (thumb operated). The focus/depth-of-field lever (4) to be on the top-aft position of the grip (thumb operated). The zoom lever (5) would encircle the audio button (finger operated). The audio button (6) would be on top and at the forward position of the grip (finger operated). A device such as standard four-button switch or a toggle switch (7) would be located on the back of the camera right hand side (clear of the viewer) to control the image access, selection and navigation. A center button would be the OK or SELECT button. Other buttons would include menu (8), display (9), and delete (10). The batteries and memory card are installed in slots behind the door on the right side of the camera. The A/V (17), USB (Universal Serial Bus) (16), HDMI (18), and the external power supply (15) ports are on the left side of the camera. (See FIGS. 1 and 2 for a typical configuration.)

### II. VIEWER ATTACHMENT

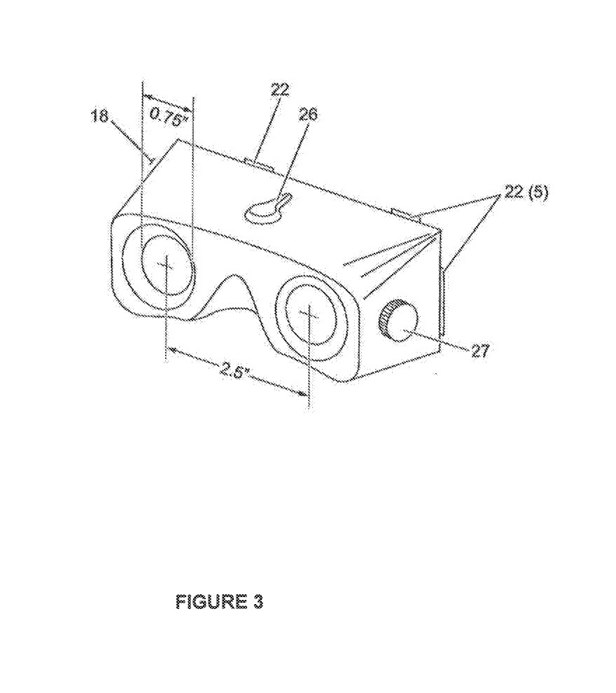

This device would be used to easily view and magnify the images in 3D in the side-by-side mode of the camera or the hand-held viewer. The 3D images are viewed on the dual LCD or lenticular screens in a 3D format for composition, depth, color, etc. of the photo being taken and for viewing after exposure. The camera and the hand-held viewer can be used without this attachment. Images can be viewed with the unaided eyes in 2D or in 3D by parallel viewing with both eyes. The viewer would attach to the back of the camera or the hand-held viewer easily and securely forming a light tight compartment, (except for the lenses). It consists of two lenses, with focal lengths as needed to view the LCD. Adjustments to include 1) simultaneous focus of both lenses and a micro focus of one lens (to match user eyes) and 2) intraocular, the distance between the lenses from about 2.3 to 2.8 inches (nominal distance to be the same as the center-to-center distance of the LCD). An adjustment lock feature may be advisable. The design would be compatible with the eyes and nose of the user, (See FIG. 3 for a typical configuration.) There is no electronics in this device.

This device will also be used to view stereo pairs, in the camera or hand-held viewer that have been saved in a memory card. The photos may be viewed individually or in a slide show format. Ability to select photo(s) for viewing or a slide show is included in the internal software of the camera and the hand held viewer,

### III. Computer Viewer

This device would be similar to the viewer attachment above, except would be specifically for viewing stereo pairs on the screen of a computer. If a 3D computer monitor is used, polarized glasses would be used to view the images. The images to be viewed would be side by side and approximately 5 inches wide each. The viewing lenses would be similar to the viewer attachment except for focal length and with an additional wedge lens, if needed, to compensate for the larger image. Stereo images can also be viewed on the computer screen by conventional means—parallel, cross-eyed, shutter glasses, or anaglyph.

### IV. Hand-Held Viewer

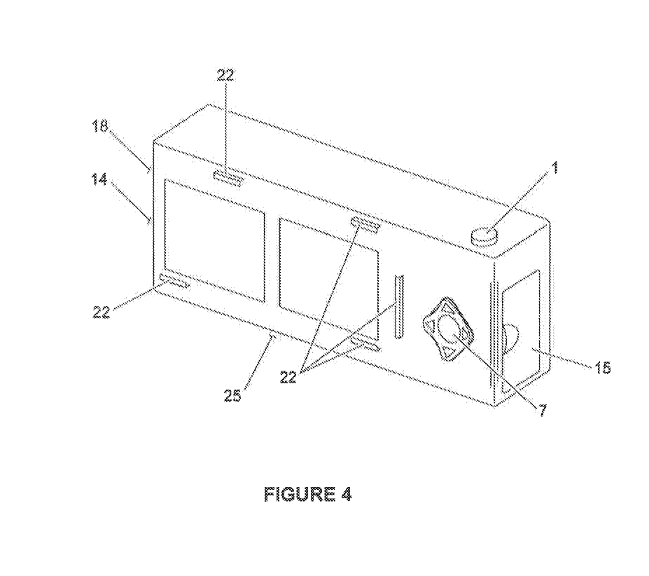

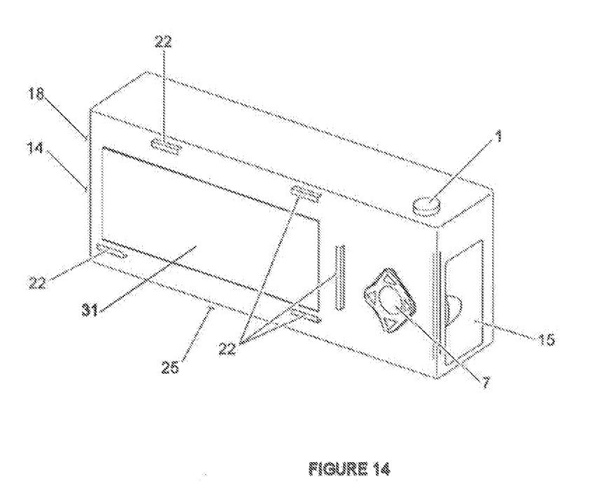

This device is to be used to view digital stereo pairs and movies in 2D or 3D without the camera. It consists of two parts—the viewer attachment as described above and a dual LCD or lenticular lens device as follows (See FIGS. 4 and 14 for typical configurations);

The dual LCD device and lenticular device would be similar to the back of the camera and include the viewer attachment feature. Memory card or device slot would be included. Viewing software would be the same as in the camera. Similar to the camera, a device such as standard four-button switch or a toggle switch would be located on the back of the viewer right hand side (clear of the viewer attachment) to control the menu access, selection and navigation. A center button would be the OK or SELECT button. Ability for selecting photos and slide show characteristics would be included in the software. Audio added to Images would play as the image is displayed.

The viewer would be powered the same as the camera, i.e. any type of battery, however AA batteries (rechargeable) are recommended. External auxiliary power supply and input to camera is included. An on/off button would enable the viewer.

Interfaces would be similar to the camera, for instance:
Auxiliary power input from included power supply;
USB (Universal Serial Bus) port to send and receive all data to and from a computer;
Audio/Video output to send signals to a VCR, DVD, and HDMI to a TV set, for recording or viewing; and
A Memory card.

### V. 3D Viewing Devices

These devices would be used to view 3D images on a computer monitor. Digital projector, a TV or 3D prints. There are five (5) types: Liquid Crystal shutter (LCS), circular polarized, linear polarized, red/cyan, and side-by-side viewer devices. Commonly, the LCS and circular polarized glasses are used for 3D TVs and 3D monitors. The LCS can be used with a standard TV with an external synchronizing device for 3D viewing. The linear polarized glasses are used with projectors. The red/cyan are used to view anaglyph images on a 2D monitor or TV, or printed on photo paper. The side-by-side devices are found in various forms. All have two viewing lenses mounted in a frame. A user holds the device up to the user's eyes to view the side-by-side images printed on photo paper. The left eye sees the left image and the right eye sees the right image as created by the camera or modified by software.

### VI. Stereo Projector

This device is needed to project stereo stills and movies onto a screen for viewing by large audiences. The projector would be a dual (stereo) projector system or two standard Digital projectors with the following unique characteristics for stereo:

Inputs would come from the camera, hand-held viewer or a computer via a USB connection. Software for photo selection and slide show characteristics are included.

The projector lenses would include interlocked zoom capability, to size the projected image to the screen. Keystone protection would be desirable. Zoom capability, to provide zooming into a specific area of an image, will also be included with the software. The projection path would include a polarized filter with the left filter rotated 45 degrees from vertical polarization, and the right filter rotated in the opposite to 45 degrees from the vertical. Circular polarization may also be used.

Alignment controls would be desirable: 1. Leveling for the projector; 2. Simultaneous focus for the lenses (plus one lens with manual micro focus adjustment for matching both lenses); 3. Vertical adjustment of one or both lenses if necessary; 4. Horizontal adjustment of one or both lenses if necessary and 5. Vertical tilt of the projector.

Brightness: The projector would have maximum brightness, because of the loss of light through the polarized filters. Polarized glasses will be worn by the viewer to separate the stereo images left and right.

### VII. Software

A. In-Camera

In-camera software would be provided to support all conventional digital camera functions, and including the stereo related functions, such as focus distance, depth-of field calculations and DOF bar, UR/Both image selection, format, resolution, etc. Image selection for viewing or adding to a slide show is included.

B. Computer Still Photo Software

Software for editing still photos would be similar to existing professional level photo editing software with the following additional features related to stereo effects.

The software will include the ability to show both left and right images on the screen (standard side-by-side, and over/under format) and the ability to select left, right, or both images for editing. Other viewing formats would include interlaced, gray anaglyph, color anaglyph, and page-flip. General editing will be conducted on one image, but simultaneously recorded on the other image, whether visible on the computer screen or not. Provisions to override this feature for specific applications would be included. Software instructions would recognize the subtle differences between the left and right images, because of the lens separation.

Editing that effects the entire image, such as brightness, contrast, intensity, equalization, color balance, gamma, hue/saturation/brightness, replace colors, sharpen, etc. will be performed on either individual image, but default matched by number on the other image, which can be changed if desired. The software for editing that effects only a portion of the image, such as masking, cloning, erasing, painting, etc. will allow for effect to be offset by the pixel differences between the image pairs, but performed on both at the same time. Because of the differences between the left and right image, the software will make allowances for effects not be performed equally on each image. Cropping will be performed on both images in the same proportion.

Horizontal and vertical alignment will be automatic or manual using aids such as an alignment grid and edge detection techniques. Horizontal alignment also controls the window position (see next paragraph). Individual images may be rotated to correct exposure errors, or for special effects.

The software will include provisions for window control. Stereo has the illusion of viewing the scene through a window. By that, your left eye will see things at the right edge of the scene that the right eye does not, and conversely, the right eye will see things at the left edge of the scene that left eye does not. This is the window effect, caused by the offset of the two lenses in the camera. Without moving the window, left and right images that are moved closer together, make the scene appear to be closer to the window. Conversely, left and right images that are moved farther apart make the scene appear to move away from the window. Another way to look at it, without moving the scene images, by moving the windows closer together the scene will appear to be farther back, or away, from the window. Conversely, again, moving the windows farther apart, the scene will appear to be closer to the window, or even in front of the window. This technique is often used to pull an object closer to or even through the window. To use this feature, a bit of the scene width will be sacrificed. When you move a window, without moving the scene, a small portion of the scene would be lost and on the other side, a blank area will appear. When moving a window, both image windows would automatically be shrunk to compensate for this. It is like cropping without removing the area outside the crop. Basic window control will be accomplished by selecting a point on the image that would appear to be located at the window depth.

All adjustments would be performed manually or automatically in a 3D view by use of keyboard arrows (up/down and left/right), or a mouse device.

Text can be added as an object and will include a selection of apparent depth, i.e. none (in the same plane as the window), deeper (text will appear back of the window), or closer (text will appear in front of the window). The text apparent depth, location and size, color, shadow, etc. will be editable as an object or a layer and seen in a 3D view.

Extra wide panoramic photos taken by swinging the camera about ⅔ of a view between exposures will be combined into a single panoramic stereo view using the stitching capability. For very wide photos, viewing may have to be by anaglyph, TV or projection techniques.

C. Printing Software

Software for printing photos would be similar to existing professional level photo editing software. Here we have the best of all worlds, printing 2D photos just like any standard digital system, or 3D stereo pairs that can be viewed in several ways. The following additional features are related to stereo effects.

Free-viewing. For viewing printed (or computer screen) stereo pairs without any optical aids. This is commonly referred to as parallel or cross-eyed viewing. The center-to-center distance of the two images is approximately 2.5 inches or less. For the parallel viewing, left images are placed on the left and right images are placed on the right and close together. The eyes should be focused at infinity (i.e. parallel) or a distant object (the eyes should not converge as if viewing a nearby object) such as that the left eye sees the left image and conversely the right eye sees the right image. Actually three images will appear and the center one is the stereo view. For cross-eye viewing, the left image is placed on the right side and the right image is placed on the left. To view, one must cross their eyes to see the stereo effect. The software will provide for selecting either technique as desired.

Optical Viewer. There are several optical viewers available on the open market for viewing side-by-side printed stereo pairs. Of olden times, the stereoscope is still very popular. By selecting the stereoscope format, the software will automatically set up the image pairs for printing. The software will also provide printed pair adjustments to control the image size, center-to-center separation, and window location as described above. The stereoscope format, commonly called the Holmes format is unique. The format is square or rounded corners and with or without the often preferred curved (dome) top side of each image. The software will provide this format selection. Text addition features will include font, color, and location control. Background color and photo color (i.e. natural, sepia, color tone, etc) will be selectable.

Anaglyph. This is a procedure whereby the stereo pairs are made through a red and cyan filters and then printed on top of each other with adjustable separation. The stereo image is viewed by using glasses with red and cyan lenses. The photographic images are processed in the normal way as described above and using the included software. Selecting the anaglyph format will automatically filter the images with the red and cyan and superimpose them on the computer screen. This presentation will be viewable on a computer screen with the standard red/cyan glasses. Printing capability is included and the printed anaglyph images will be viewed in the same manner.

Included in the anaglyph will be the ability to produce pop-up or phantograms. Pop-ups start with the camera taking a photo of objects on a flat surface such as a table. The angle of the camera to the horizontal plane is down from 30 to 45 degrees. A tripod and slide bar is required to get the proper lens separation. The software modifies the images to correct alignment errors and to prepare for viewing. Viewing is a very unique procedure. The printed anaglyph photo is placed on a horizontal surface such as a table. A very large photo may be placed on the ground or floor. The image is viewed wearing the red/cyan glasses and looking at an angle similar to the camera angle. The images appear to pop up into the air.

Anaglyph photos are easy to share. The 3D photos can be mailed or e-mailed. All that is needed by the recipient is relatively cheap red/cyan glasses,

### VIII. DVD and BD Players and VCR

Any standard BD or DVD Player or VCR, when equipped with a 3D TV Box such as X3D TV Box manufactured by X3D Technologies or equivalent, would be used to play the 3D images on a standard TV. A 3D DVD or BD player is required for current technologies such as 3D TVs and the 3D box is not needed. Viewing stereo images in a sequence is commonly called a slide show (from the film format). Software for creating the slide show and copying to a VHS tape or a BD or DVD is included.

### IX. Accessories

A. Slide Bar

This device would be used for hypo-stereo and hyper-stereo photos. It must have a tripod attachment insert on the bottom and a camera attachment on the top for interfacing with these items. Adjustment for specific camera lens separation would be incorporated. The device would allow sliding of the top section with the camera attached) to the left and right positions for the exposures. The left and right images are taken separately (non-moving subject) using the slide bar to locate the exposure separation. A measuring scale, in inches or centimeters, would be provided to accurately adjust the exposure separation. In a preferred embodiment, the total adjustment would be approximately 0 to 6 inches. A built-in retractable scale in inches and centimeters up to about 36 inches long would be desirable to accurately measure the distance from the camera to a close-up object.

B. Tripod

A conventional standard tripod is included in the system.

C. Viewing Glasses

Devices for viewing 3D images on a computer screen, prints, or a standard TV is included in the system. Several commercial viewers are available, including the following:

Red/Cyan glasses for viewing photographic prints or images on a computer screen and standard TVs that are in an anaglyph format.

Polarized glasses for viewing projected stereo or 3D TV. Conventional commercial glasses are available for this purpose.

Liquid crystal shutter glasses and side-by-side view devices for viewing 3D images on a computer screen, and standard or 3D TV.

D. Projector Screen

A standard lenticular screen can be used with 3D photos and movies projected with polarized filters in front of the lenses and polarized glasses worn by the viewers.

One can also fashion a home version using large sheets of white paper attached to a wooden frame.

Now that a general overview of the components and system of the present invention has been introduced above, the following description refers to the specific drawings that embody those components and operational features.

FIGS. 1 and 2 illustrate the camera in a typical configuration and identifies all the controls and design characteristics.

FIG. 3 illustrates the viewer attachment view from the user's side. The viewer would be configured to match up with the LCDs 30L and 30R or lenticular screen 31 of the camera and easily attach.

FIG. 4 illustrates the hand-held viewer and identifies all the controls and design characteristics. The back is similar to the camera, and contains only that electronics needed for viewing images and adding text. Viewing can be by the unaided eyes or with the viewer attachment.

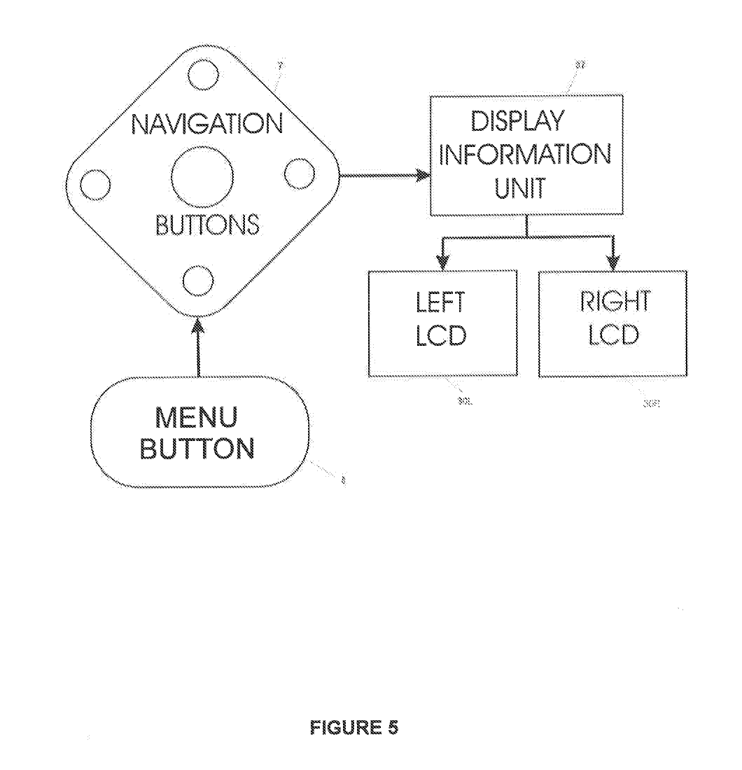

FIG. 5 illustrates the camera set up mode. This is the interface with all menu functions. Pressing the menu button 8 accesses the menu and the navigation buttons 7 are used to search through the menu to access the desired functions. The menu and data is processed by the display information unit 37 and displayed on the left and/or right LCD 30L and 30R.

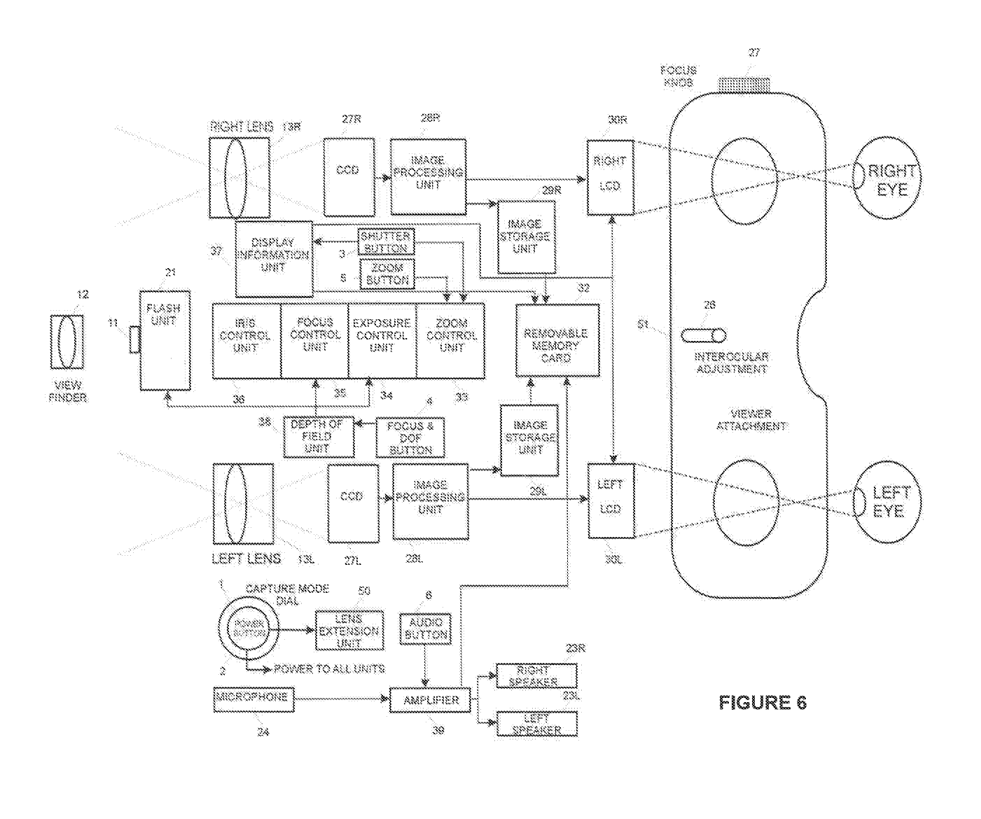

FIG. 6 illustrates the camera capture mode. The camera is powered by internal batteries or an external power supply. Power is enabled by pressing the power button 1. This action supplies power to all mechanical and electronic units in the camera and extends the retracted lenses. The capture mode dial 2 is rotated to select the photographic style (3D, 2D, Movie, Night (dark scene), or

Filtered). All styles are 3D except the 2D style. The 3D style is described herein. Light rays from the object would enter the left and right lens 13L and 13R and be projected onto the charge coupled Devices (CCDs) 27L and 27R. The formed image data is processed by the image processing units 28L and 28R, and then sent to the image storage units 29L and 29R and to the Liquid Crystal Displays (LCDs) 30L and 30R, or the lenticular screen 31 in place of the dual LCDs, for viewing in the camera directly or through the viewer attachment 51. For 3D, the viewing mode can be set to the lenticular 3D or the side-by-side mode. Pressing the shutter button 3 half way enables the zoom control unit 33, the exposure control unit 34, the focus unit 35 and the iris control unit 36.

If zooming is desired, the zoom button 5 is rotated to activate the zoom control unit 33. The focus control unit 35 performs focusing automatically unless the focus/DOF lever 4 is rotated for manual control. If focusing or changing the depth of field (DOF), the focus/DOF lever 4 is rotated activating the focus/DOF unit 38 and focus control unit 35. Exposure (shutter speed) is selected automatically by the exposure control unit 34, unless manual or shutter priority is selected from the menu. Iris opening is performed automatically by the iris control unit 36 unless manual or aperture priority is selected from the menu. When the image is satisfactory, the shutter button is pressed again all the way to activate the shutter. The image storage units format the images and associated significant data and stores it in the removable memory card 32. The associated data includes exposure information (i.e. shutter speed and f stop), date, time, capture number, ISO, and quality level.

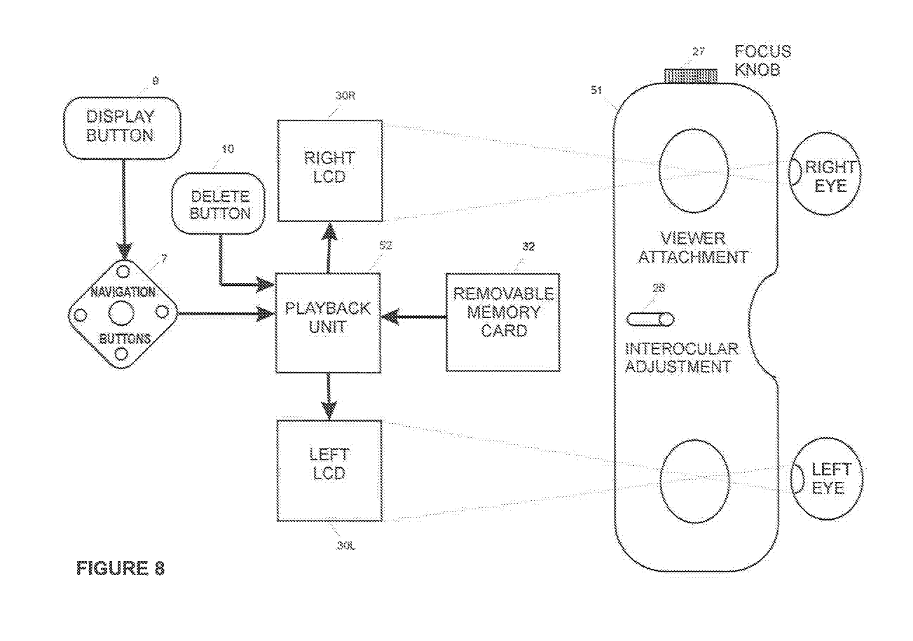

Audio may added to each image, prior to exposure or after capture. The audio button 6 is pressed initially to enable the audio function, power up the amplifier 39 and to display “AUDIO ENABLED® PRESS TO START” on the LCD 30R. Pressing the audio button 6 again will start the recording and display, on the LCD 30R a countdown of the remaining time. After recording, “PRESS TO PLAY AUDIO” will be displayed on the LCD 30R for several seconds and pressing the button will play the audio. If not satisfied with the results, the process can be repeated, overwriting the previous recording. If recorded prior to exposure, the audio is saved on the removable memory card 32 with the next captured image. To record after capture, the display button 9 is pressed and the desired image selected with the navigation buttons 7 (as shown in FIG. 8), followed by the above procedure. Audio may also be added in a computer while editing. For audio in movie mode, all ambient sounds picked up by the microphone will be recorded and saved. Additional audio may be added by a computer during editing.

Flash illumination may be selected by the menu to be on always, or as needed, using the internal flash unit 23 or an external flash attached to the hot shoe 20 (as shown in FIGS. 1 and 2). The duration of the internal flash is controlled by flash unit 21, measuring the light with the flash light sensor.

Viewing the image before capture may be done in one of three modes unaided eyes directly to the dual LCDs or the Lenticular screen, aided eyes with the viewer attachment, or with the viewfinder 12 (2 dimensional only).

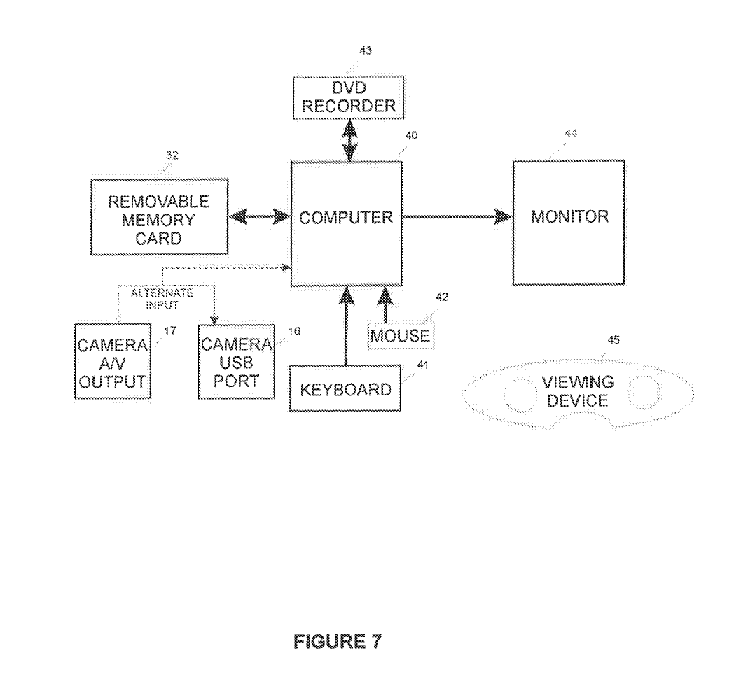

FIG. 7 illustrates the computer editing and viewing mode. Images on the removable memory card 32 are downloaded to the computer 40. The camera also includes an Audio/Video (AN) or an HDMI port 17 and a Universal Serial Bus (USB) port 16 that can be used with proper cabling to download to the computer 40. The computer 40 is used to display images on the monitor 44, and to edit images using software, and the keyboard 41 and/or a mouse 42. The images may be viewed by eye on the monitor in 2D or in 3D using a viewing device or special glasses 45 (such as shutter glasses) or on a 3D computer/monitor, such as the Sharp RD3D with the unaided eye or by using polarized glasses. The software can also be used to create “slide shows” (a term from the film days) to assemble images into a sequence for presentation to viewers. The software provides the capability of uploading images, slide shows, or movies to a removable memory card, which can be inserted into the camera, the handheld viewer or a reader/writer device attached to another computer.

FIG. 8 illustrates the side-by-side viewing mode in the camera or in the hand held viewer. The left and right images are displayed on the left and right

LCDs 30L and 30R respectively. The removable memory card 32 or other memory device is inserted into either the camera or hand-held viewer. Pressing the display button 9 enables the image display. The playback unit 52 processes the data from the card and displays the images on the LCDs 30L and 30R, utilizing the viewing mode selected in the menu (side-by-side 3D, or 2D). Selection of the desired viewing mode and image is performed with the navigation buttons. Undesirable images may be removed from the memory card with the delete button 10. Images may be viewed individually or (when selected via the menu) in a slide show. If audio had been added, it will be heard in the speakers 23. Audio can also be added to the selected image in the camera or the hand held viewer.

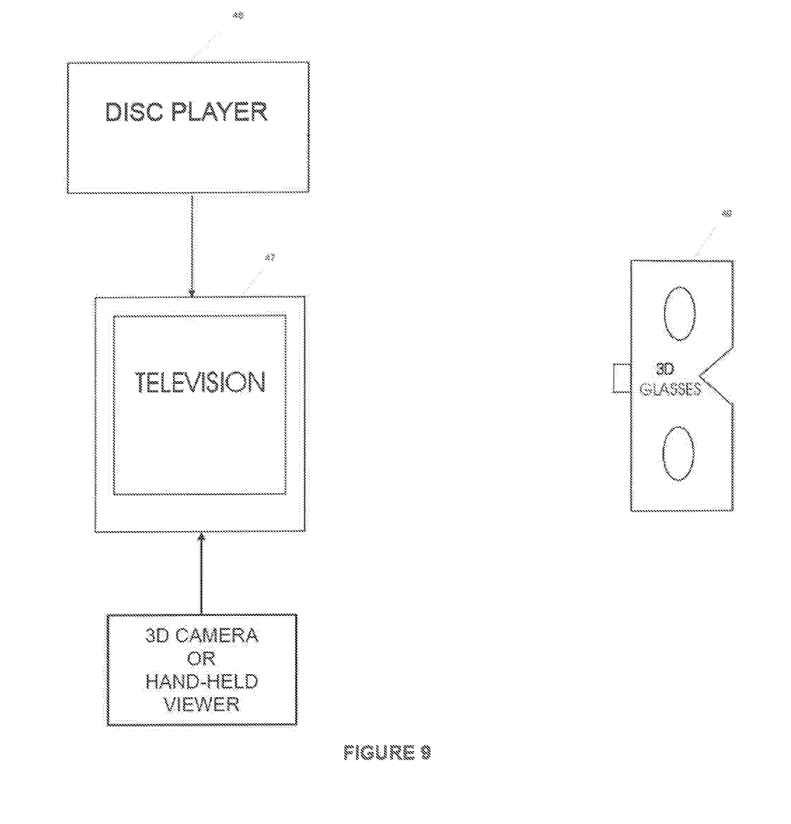

FIG. 9 illustrates the TV viewing mode. Input is from one of three (3) sources: A DVD or BD player, the camera, or the hand-held viewer. A disc containing the images is inserted in a DVD or BD player or a memory card is inserted into the camera or the hand held viewer and the contents are transmitted to a TV via an HDMI cables. For a standard TV, these devices send Audio/Video signals through an infrared synchronizing device 48 to the TV 47. This synchronizing device senses the alternating left and right images and sends an infrared signal to Liquid Crystal Shutter (LCS) glasses 49 or other appropriate 3D glasses. The LCS glasses allow the TV image to pass through to one eye and be blocked in synch with the alternating left and right images. For 3D TVs the synchronizing device is not needed and LCS or polarized glasses, as appropriate for the TV is used.

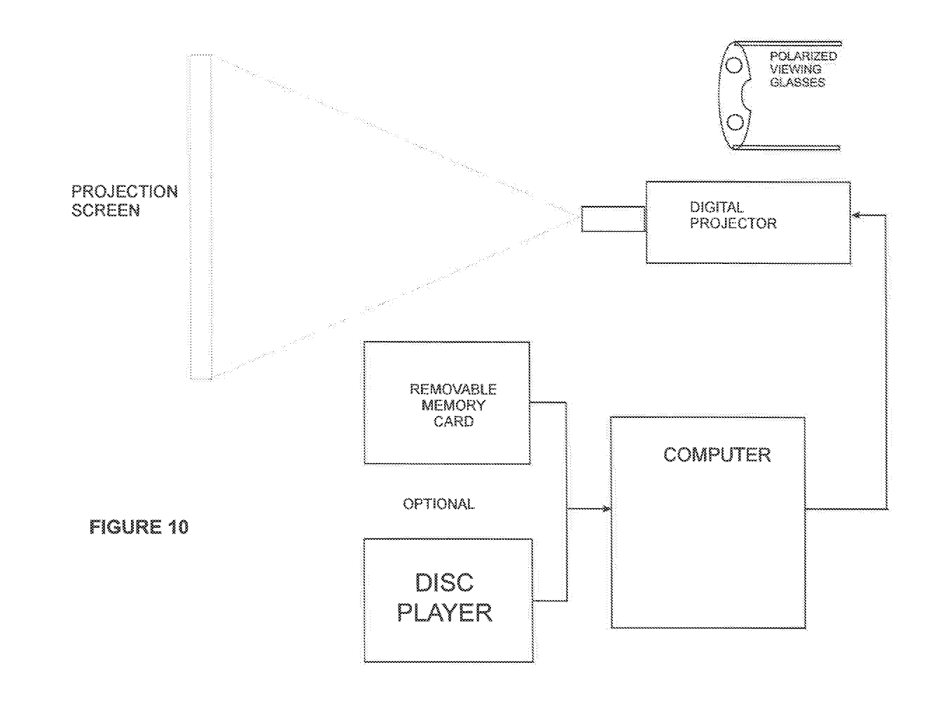

FIG. 10 illustrates the projection mode that can be used for large or small audiences. Images saved or recorded to a removable memory card 32 or a DVD or BD disc are downloaded to a computer or played through a computer. The left and right images are sent to a 3D digital projector or to two 2D digital projectors which in turn project the images onto a lenticular or flat panel screen. The projectors are fitted with polarized filters and polarized viewing glasses must be worn by the observers.

FIG. 11 illustrates typical LCD 30L and 30R side-by-side views in the Depth of Field (DOF) view of the capture mode. With the viewer attachment 51 in place this view would be in 3D. In lenticular viewing mode, the left and right images are interlaced behind a lenticular screen 31 and the use of viewer attachment is not required. In the DOF or Auto/DOF mode, pressing the shutter button 3 halfway enables the capture mode. Moving the focus DOF lever 4 enables the DOF view. Rotating the DOF lever 4 will display the distance-from-camera scale, the DOF range, and the focus distance. In addition, alignment lines will show to aid in aligning the photo. When the camera is focused, an indication will appear. Other information displayed includes the date and time, image number, number of images remaining on the removable memory card 32, battery condition, f-stop, and shutter speed.

FIG. 12 illustrates typical side-by-side viewing mode LCD 30L and 30R views in the capture or viewing mode. In the lenticular viewing mode, the left and right images would be interlaced behind the lenticular screen. This view is present after focusing or setting the DOF, and in the automatic focus/DOF mode. If the image is not in focus, a pair of parentheses in red appear. When the camera is focused manually or automatically, the parentheses change to green and moved closer together. The camera is now ready for exposure. Other information displayed includes image number, number of images remaining, f-stop, shutter speed, and battery status. When the shutter button is pressed, and the battery is low, a large red battery outline and the warning “LOW BATTERY” will appear in an LCD. This message will hold for 20 seconds. Pressing the shutter button 3 again fully captures the image and saves it on the removable memory card 32,

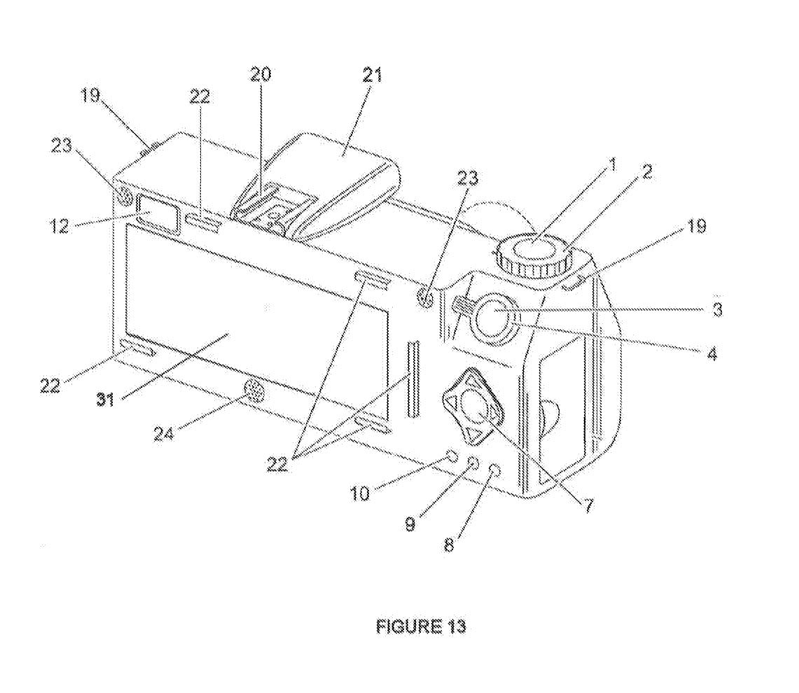

FIG. 13 is a perspective view of the camera having a Lenticular screen 31. The Lenticular screen replaces the left and right LCDs 30L and 30R as shown in FIG. 1. The Lenticular screen 31 is capable of simultaneously displaying the output from the left and right CCD 27L and 27R. Viewing is by the unaided eyes. In certain embodiments, the images displayed on the Lenticular screen 31 are displayed in a side-by-side configuration and may be viewed with the unaided eyes or with the use of the viewer attachment shown in FIG. 3.

FIG. 14 is a perspective view of the hand-held viewing apparatus having a Lenticular lens instead of left and right LCDs 30L and 30R as shown in FIG. 4. The hand held viewing apparatus having the Lenticular lens functions similar to the hand-held viewing apparatus having left and right LCDs (see FIG. 4) have been replaced with a Lenticular lens. The operation of the Lenticular lens is similar to the description above in regards to FIG. 13,

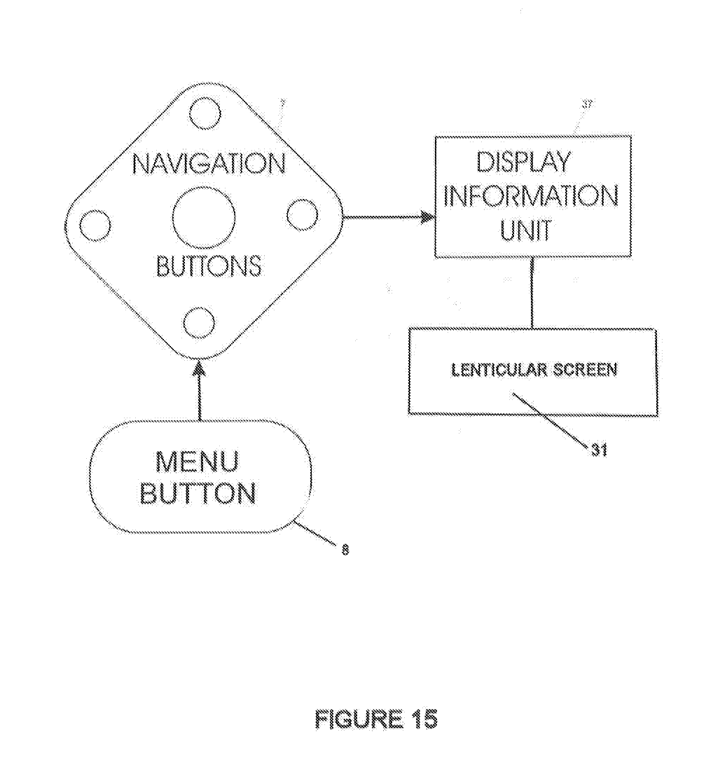

FIG. 15 is a block diagram illustrating the operational flow of information in the camera set-up mode where the camera uses a Lenticular lens 31 instead of a left and right LCD. FIG. 5 illustrates the camera setup mode used with the dual LCD lens. This is the interface with all menu functions. Pressing the menu button 8 accesses the menu and the navigation buttons 7 are used to search through the menu to access the desired functions. The menu and data is processed by the display information unit 37 and displayed on the Lenticular screen 31,

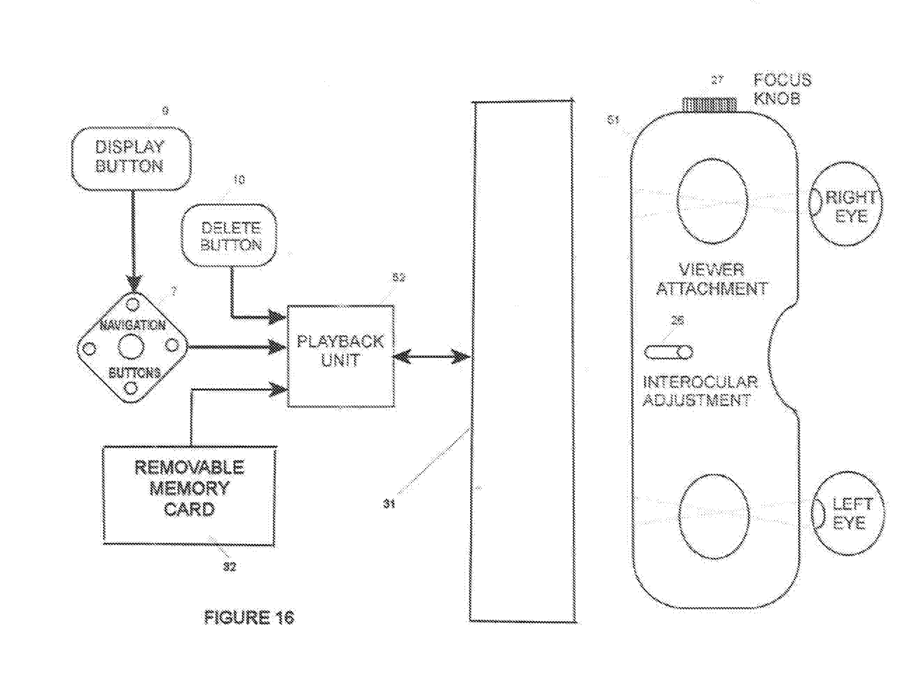

Lastly, FIG. 16 is a block diagram, similar to FIG. 8, except the dual LCDs are replaced with a Lenticular screen 31, illustrating the operational flow of information in the camera and hand-held viewer. FIG. 8 illustrates the side-by-side viewing mode in the camera and in the hand-held viewer. In the lenticular mode, the left and right images are interlaced behind the lenticular screen 31. The removable memory card 32 is inserted into either device. Pressing the display button 9 enables the image display. The playback unit 52 processes the data from the card and displays the images on the lenticular screen 31, utilizing the viewing mode selected in the menu (side-by-side 3D, lenticular 3D, or 2D). Selection of the desired viewing mode and image is performed with the navigation buttons. Undesirable images may be removed from the memory card with the delete button 10. Images may be viewed individually or (when selected via the menu) in a slide show. If audio had been added, it will be heard in the speakers 23. Audio can also be added to the selected image in the camera or the hand held viewer. The viewer attachment may be used in the side-by-side view.

While there have been shown what are presently considered to be preferred embodiments of the present invention, it will be apparent to those skilled in the art that various changes and modifications can be made herein without departing from the scope and spirit of the invention.

I claim:

1. A stand-alone digital camera capable of taking three dimensional as well as two dimensional photographs, comprising:
a pair of identical and linked lenses equipped with variable focus, variable aperture, and zoom capabilities;
an image capture device for each of said lenses and in optical communication therewith;
an image display configured to simultaneously display an image for each of said image capture devices;
a means for capturing an image passing through said lenses;
a means for storing said captured image;
a means for displaying said captured image on said image display;
a means for recording audio before, during, and after capturing of said image;
a means to remotely control the digital camera; and
a means to set Depth of Field.

2. The stand-alone digital camera of claim 1, wherein the image display is further configured to simultaneously display the image for each of said image capture devices side by side on the image display.

3. The stand-alone digital camera of claim 1, wherein said image display is a Lenticular screen configured to display interlaced images in Lenticular three-dimensional and traditional two-dimensional formats allowing images to be viewed with unaided eyes.

4. The stand-alone digital camera of claim 3, wherein said image display is a Lenticular screen further configured to display images in side-by-side three-dimensional format.

5. The stand-alone digital camera of claim 1, further comprising a viewer attachment removably positionable adjacent to the image display of the said stand-alone digital camera to aid in viewing the captured photos, comprising:
a frame with space provisions for a users nose;
a pair of viewing lenses where said lenses are spaced apart corresponding to the separation of a user's eyes;
an adjustment for the simultaneous focus of both lenses;
an adjustment for micro focus of one lens;
an adjustment for interocular spacing; and
an adjustment lock to lock said adjustments.

6. The stand-alone digital camera of claim 1 configured to capture both left and right exposures simultaneously or capture left and right exposures individually to create hypo-stereo (large lens separation) or hypo-stereo (narrow lens separation) 3D images where the image of the first exposure is displayed and retained in the image display to aid in alignment while capturing the second exposure or additional exposures.

7. The stand-alone camera of claim 1, the camera further configured to capture and display movies in three-dimensional or two-dimensional format.

8. The stand-alone digital camera of claim 1 the camera further configured to zoom before or during the capture of a movie.

9. The stand-alone camera of claim 1, further comprising a built-hi flash and a hot shoe configured to enable the use of an external flash unit.

10. The stand-alone camera of claim 1, the camera further configured to add audio to corresponding images or movies before, during (for movies), and after exposure in the camera.

11. The stand-alone camera of claim 1, the camera further configured to erase undesirable images or movies from the memory device.

12. The stand-alone digital camera of claim 1 further comprising displaying image and camera information on the image display, including focus distance of the camera, Depth of Field, alignment lines, battery status, shutter speed, f-stop, date, time, image number identification, image number remaining in memory.

13. The stand-alone digital camera of claim 1, further comprising multiple ISO (International Organization for Standardization) speeds selectable from a menu.

14. A hand-held stereoscopic viewer, comprising:
an image display capable of simultaneously displaying a plurality of images;
a memory card slot;
a switch for menu access, item selection, and navigation;
a means to play audio associated with the image being viewed;
a means to removably attach a viewer attachment;
a means to power said hand-held stereoscopic viewer,
a means to turn power on and off;
a means for transferring data to or from said hand-held stereoscopic viewer and a stand-alone computer; and
a means for displaying said captured image on said image display.

15. A method of processing and editing images using computer software on an a separate stand-alone computer platform to modify image brightness, contrast, intensity, equalization, color balance, gamma, hue/saturation, color replacement, sharpness and 3D characteristics of horizontal, vertical and rotational alignment, cropping, apparent window location control, and printing in 3D formats including side-by-side, over-under, anaglyph, pop-up phantograms, and standard stereoscopic cards (Holmes).

16. The method of claim 15 further comprising the step of adding text in 3D format, where the depth position of said text relative to the window and scene is adjustable by the user.

17. The method of claim 15 further comprising the step of creating panoramic views by stitching two or more already existing 2D or 3D images to form the panoramic view.

18. The method of claim 15 further comprising the step of transferring images, slide shows, and movies to a CD, DVD, BD, or other storage media.

19. The method of claim 15 further comprising the step of creating and editing slide shows and movies and transferring the slide shows and movies to a storage device using software for use on a stand-alone computer.

20. The method of claim 15 further comprising the step of playing back audio when viewing its corresponding image or movie clip.
